(19) United States
(12) Patent Application Publication
(10) Pub. No.: US 2003/0221598 A1
(43) Pub. Date: Dec. 4, 2003

(54) Sea grass slab planter with arcuate bucket and related process

(76) Inventor: James F. Anderson, Ruskin, FL (US)

Correspondence Address: DONALD R. BAHR, 2608 MERIDA LN, TAMPA, FL, 33618, US

(21) Appl. No.: 10/413,315

(22) Filed: Apr. 14, 2003

Related U.S. Application Data
(63) Continuation-in-part of application No. 10/077,397, filed on Feb. 15, 2002.
(60) Provisional application No. 60/372,830, filed on Apr. 16, 2002.

(51) Int. Cl. A01C 11/00

(52) U.S. Cl. 111/101

(57) ABSTRACT

The planting of individual sea grass plants or small bunches of sea grass plants is known in the prior art. In the prior art these plantings are made either manually or with appropriate machinery. This invention deals with the digging, transporting and planting of large slabs of sea grass. The process of the invention comprises the steps of digging a slab of sea grass, transporting the slab of sea grass to a new location, digging a furrow with the same apparatus that is used to dig the slab of sea grass and depositing the slab of sea grass in the furrow. In this invention the digging of a sea grass slab may be effected with a clam shell type bucket. The surfaces of the clam shell type bucket which support the sea grass slab are acruate. A mechanical assist sweep arm for the removal of the sea grass slab, from the clam shell bucket, is further provided for.

### RELATED APPLICATIONS

This application is a continuation in part application of application Ser. No. 10/077,397 and claims priority of provisional application S. No. 60/372,830 filed Apr. 16, 2002.

### BACKGROUND

This invention is concerned with a process and related apparatus whereby aquatic plants may be planted underwater for purposes of restoration. The restoration of all aspects of the environment has become extremely important in recent years. The three areas of restoration which are of primary importance are reducing air pollution, restoring and cleaning up the land and cleaning up and restoring our waterways, the ocean and related estuaries. It is these related estuaries that are the primary thrust of the subject invention.

As a result of the decrease in water quality millions of acres of aquatic plant life, which form an important part of the aquatic eco system have been destroyed. That is because of a decrease in water quality, in other words pollution, aquatic plant life has been destroyed. In most cases this destruction has been gradual over a long period of years however in some instances it can be rapid, for example as a result of a shipwreck.

Because aquatic plant life is an important part of the complex aquatic environment the restoration of this plant life is of primary importance.

The natural restoration of aquatic plant life is an extremely slow process. While it is possible to manually plant shoots of aquatic plants, due to the cost of labor the manual planting of sea grass plants is at best marginally successful. Due to the difficulty of manually planting shoots of aquatic plants, the cost of manually planting just one acre of an estuary can cost many tens of thousands of dollars. Further manual planting in some instances is of questionable success as the person doing the planting, in walking over the bottom of an estuary does further damage by crushing other plants which may be growing in the area.

This invention is concerned with a process and apparatus whereby sea grass can be quickly planted in an economical fashion.

As used in connection with this invention the term aquatic plant life and sea grass includes many species of plant life such as halodule, wrightii (shoal grass), thalassia (turtle grass) etc.

Aquatic plant life as it exists in estuaries is important in preventing water pollution as this plant life acts as a filter for many pollutants and hence this plant life helps to maintain water quality.

The restoration of aquatic life to the bottom of our estuaries is extremely important as this aquatic plant life plays a critical function in the total marine eco system. A large number of important marine animals, both warm and cold blooded, rely totally or in part on this aquatic plant life for a breeding area, for cover, for food etc. for example the endangered manatee relies solely on sea grass as its food source.

### OBJECTS

The primary object of this invention is a process whereby aquatic plant life may be dug, repositioned on and replanted on the bottom of an estuary.

Still another object is related apparatus whereby this planting may be effected with minimal damage to the bottom of the estuary.

Still another object of this invention is apparatus whereby large slabs of aquatic plants may be planted on the bottom of an estuary.

Another object is a sea grass planter which automatically makes a furrow for the planting of a slab of sea grass.

Lastly an object of this invention is a sea grass planter which incorporates a bucket with arcurate surfaces.

### DESCRIPTION OF THE DRAWINGS

FIG. 1 is a perspective view showing the sea grass planter on its floating platform.

FIG. 2 is a cutaway perspective view showing the sea grass planter and its support.

FIG. 3 is a side view showing the sea grass planter in its initial engagement with the estuary bottom.

FIG. 4 is a side view showing the sea grass planter removing a slab of sea grass from the estuary bottom.

FIG. 5 is a cut away side view showing the initial contact of the sea grass planter with the estuary bottom during the planting sequence.

FIG. 6 is a cut away side view showing the sea grass planter in the final stages of planting a slab of sea grass.

### BRIEF DESCRIPTION OF THE INVENTION

The subject invention relates to a process for planting aquatic plants such as a wide variety of sea grass. The invention is also concerned with apparatus whereby large slabs of aquatic plants may be dug, transplanted and planted in accordance with this invention. The planting of these slabs of sea grass is to be contrasted with the prior art wherein individual plants or small bunches of plants are planted with a spade.

The process of this invention in its broadest terms comprises the digging and positioning of a slab of sea grass at a new location wherein a furrow is automatically formed.

As is shown in U.S. Pat. No. 6,070,537 issued Jun. 6, 2000, individual aquatic plants may be planted. While the planting of these plants is highly successful it is not feasible to use the process and apparatus to plant large areas of sea grass if continuous coverage of large areas is desired on a short term basis. By use of the process and apparatus of the U.S. Pat. No. 6,070,537 continuous coverage can be achieved only over an extended period of time. That is in order to achieve continuous coverage the individual plants as are planted by the process of U.S. Pat. No. 6,070,537 must grow and multiply in order to effect continuous coverage. This growing process takes an extended period of time.

In contrast to planting individual plants the process and apparatus of this invention picks up large slabs of aquatic plants, transports the slabs to a new location and plants the slabs. The replanted slabs contain thousands of individual aquatic plants. The process and apparatus of this invention is advantageous in that, a furrow to replant the sea grass slab, is automatically formed by the same apparatus which digs the slab.

### DESCRIPTION OF THE PREFERRED EMBODIMENT

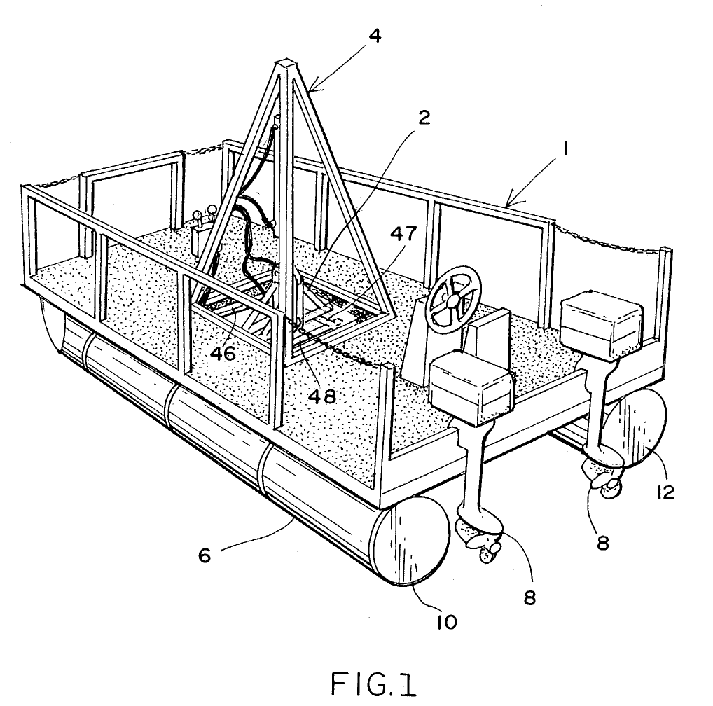

Referring to FIG. 1 it can be seen that the composite apparatus of this invention comprises a hull 6 and a sea grass slab digger/planter 2 which is supported by support 4. Hull 6 is illustrated as a bihull which is preferred as this design permits digger/planter 2 to be located between hull segments 10 and 12. As a result of this arrangement the digging and planting of sea grass slabs can be effected through hull 6. Further because of the central location of digger/planter 2 a stable platform is provided for. The composite structure may be powered by any suitable power source such as a pair of outboard motors 8 as is illustrated.

In operation hull 6 is positioned over the section of the estuary bottom where the sea grass slab is to be dug. Digger/planter 2 is then used to dig a slab of sea grass contained therein. Outboard motors 8 are then used to move the composite structure to the area where the sea grass slab is to be planted. Digger/planter 2 is then lowered to the estuary bottom and a forrow is dug by digger/planter 2 and the slab of sea grass deposited in the furrow. The process whereby the slab of sea grass is dug, transported and planted will be described in detail herein below.

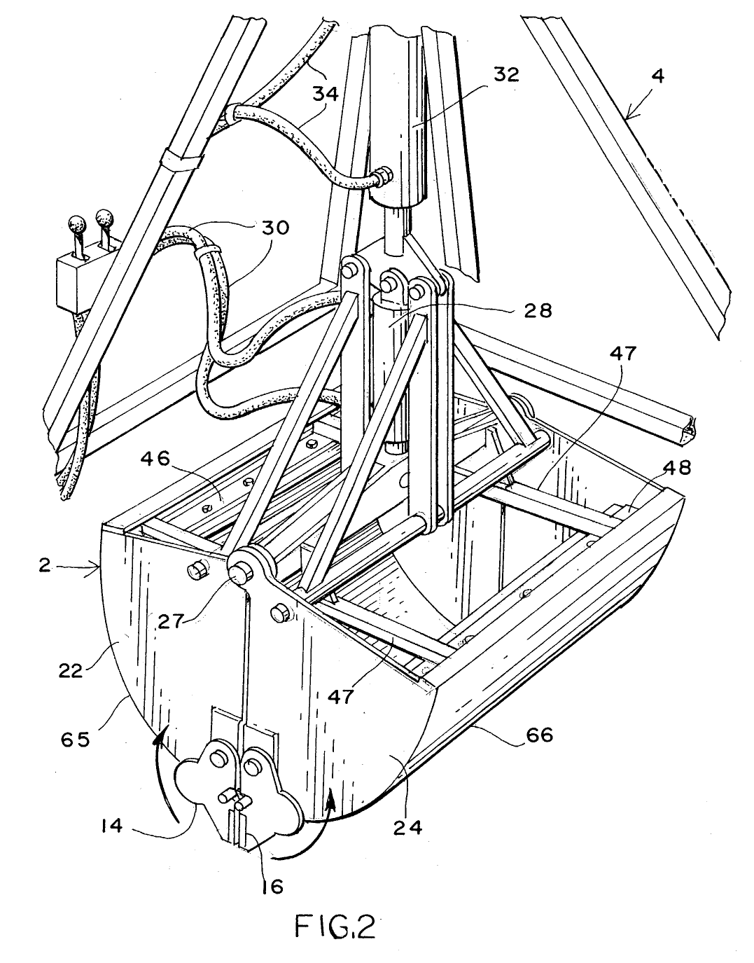

Referring to FIG. 2 it can be seen that digger/planter 2 is supported on a pyramid shaped support 4. It is understood by one skilled in the art that support 4 can assume any convenient shape.

Digger/planter 2 incorporates a pair of primary jaws 22 and 24 and a pair of secondary jaws 14 and 16. Primary jaws 22 and 24 are used to dig the slab of sea grass which is to be transplanted. Secondary jaws 14 and 16 are used to dig the furrow into which the sea grass slab is to be planted. Throughout this application when the term sea grass slab is used this term relates to a section of the estuary bottom i.e. sand, soil, organic matter and the living sea grass plants which are growing therein. The size of these slabs is controlled by the dimensions of primary jaws 22 and 24. The sea grass slabs in accordance with this invention can be of any convenient size, a preferred size for use with the process and apparatus of this invention is four by five feet.

Primary jaws 22 and 24 of planter/digger 2 are pivotally connected to each other via pivot pin 27. Power to open and close primary jaws 22 and 24 is provided by hydraulic cylinder 28 which is in turn supplied with hydraulic power via hydraulic lines 30.

The vertical movement of digger/planter 2 is controlled by hydraulic cylinder 32 which is in turn supplied with hydraulic power by hydraulic lines 34.

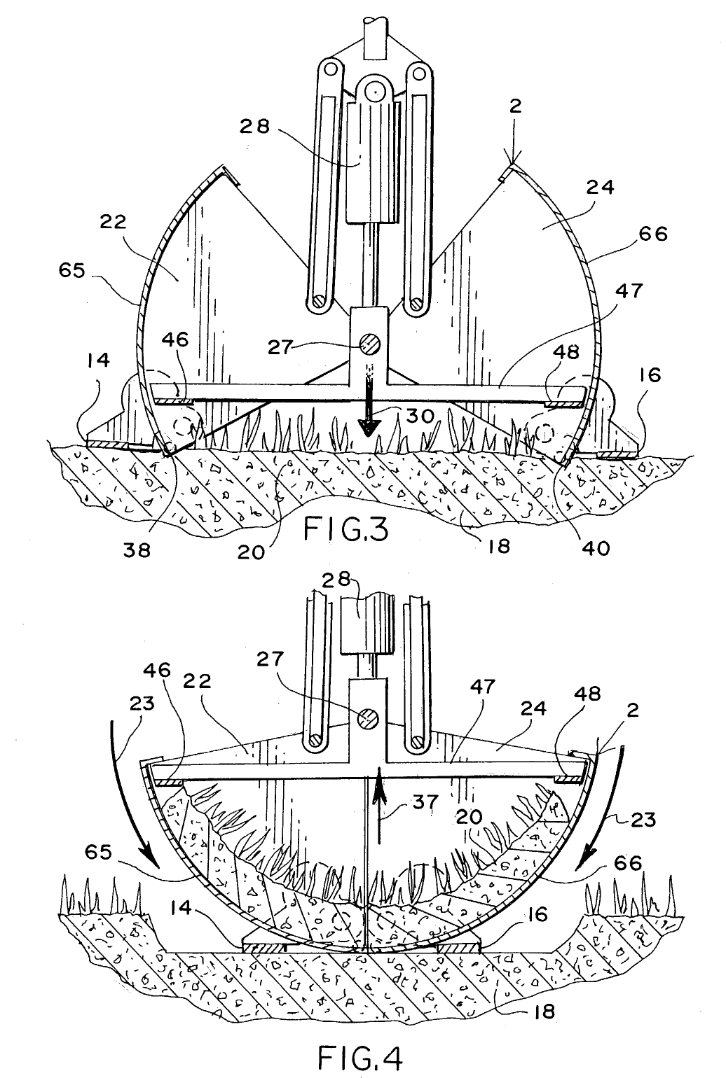

The sequence of the digging and planting cycle in accordance with this invention is illustrated in FIGS. 3-6.

In the initial sequence of the planting cycle in accordance with the process of this invention primary jaws 22 and 24 are opened by the action of hydraulic cylinder 28. As is shown in FIG. 3 digger/planter 2 is then lowered in the direction of arrow 30.

The weight of digger/planter 2 is usually sufficient to cause the leading edges 38 and 40 of digger/planter 2 to penetrate into estuary bottom 18 five to six inches. If estuary bottom 18 is particularly hard additional downward thrust in the direction of arrow 30 can be provided by hydraulic cylinder 28.

As is shown in FIG. 3 once leading edges 38 and 40 of primary jaws 22 and 24 have penetrated estuary bottom 18 a slab 20 of sea grass is encompassed. Further as can be seen sweep arm 47 is passive with its outer edges 46 and 48 approximate leading edges 38 and 40 of primary jaws 22 and 24

As can be seen from FIGS. 2-6 primary jaws 22 and 24 of digger/planter 2 further incorporate a pair of secondary jaws 14 and 16. In the initial digging of sea grass slab 20, as is shown in FIG. 3 secondary jaws 14 and 16 are passive.

As is shown in FIG. 4 when primary jaws 22 and 24 are closed, in the direction of arrows 23, via the action of hydraulic cylinder 28 sea grass slab 20 is removed from estuary bottom 18. Again during this sequence secondary jaws 14 and 16 remain passive. At this stage sweep arm is again passive with its outer edges 46 ands 48 approximate the upper portion of primary jaws 22 and 24.

At this stage digger/planter 2, with primary jaws 22 and 24 closed is drawn upward by the action of hydraulic cylinder 32 in the direction of arrow 37. Digger/planter 2 is drawn up on support 4 to such a degree that it clears estuary bottom 18. Preferably digger/planter 2 is drawn up such that its bottom extremities just clear the keels of hulls 10 and 12.

With this placement of digger/planter 2 outboard motors 8 are started and boat 1 is directed to the spot where the sea grass is to be planted.

Referring to FIG. 5 when the composite assembly is positioned over the estuary bottom where slab 20 is to be planted digger/planter 2 is lowered down in the direction of arrow 41.

Prior to lowering digger/planter 2 down secondly jaws 14 and 16 are locked in a vertical stance. Secondly jaws 14 and 16 are no longer passive. As digger/planter 2 is lowered in the direction of arrow 41 secondary jaws 14 and 16 penetrate estuary bottom 18. Under normal circumstances the weight of digger/planter 2 with sea grass slab 20 continued therein is sufficient to cause secondary jaws 14 and 18 to penetrate estuary bottom 18. If estuary bottom 18 is exceptionally hard additional downward thrust to cause secondary jaws 14 and 18 to penetrate estuary bottom can be supplied by hydraulic cylinder 32.

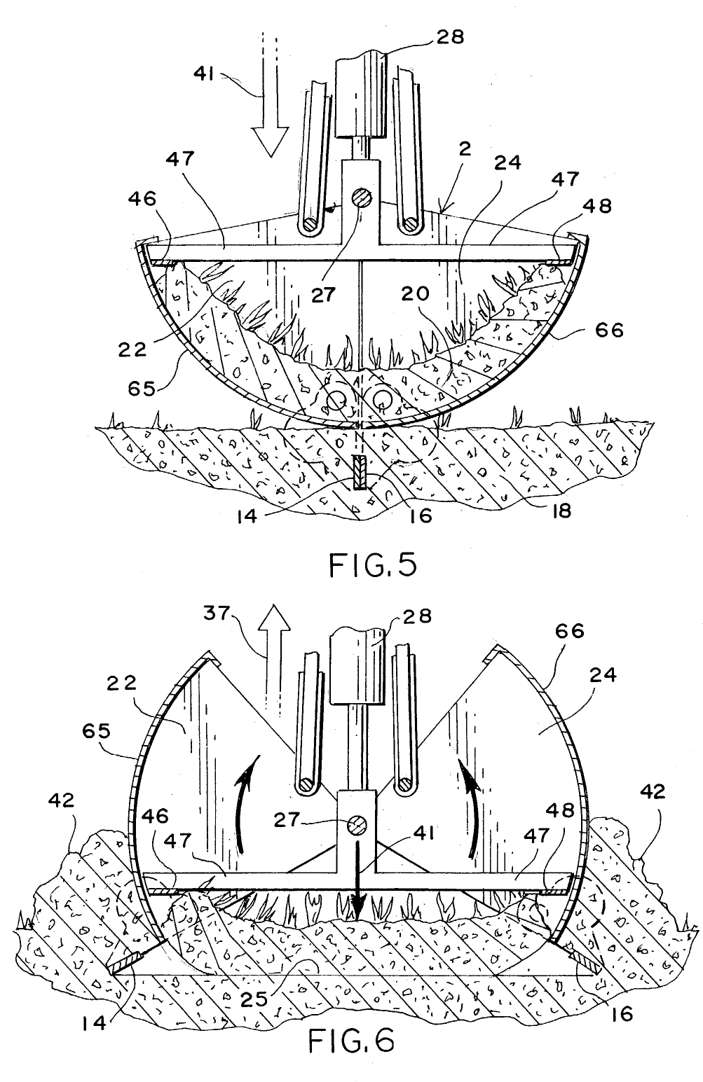

Referring to FIGS. 5 and 6 once secondary jaws 14 and 16 have penetrated estuary bottom 18 primary jaws 22 and 24 are caused to open by the action of hydraulic cylinder 28. This opening action causes secondary jaws 14 and 16 which are locked into position to plow a furrow 25 in estuary bottom 18. Rubble 42 is pushed aside as furrow 25 is formed. Rubble 42 is usually quickly dissipated by the action of currents i.e. tidal currents. As furrow 25 is formed sea grass slab 20 falls by the action of gravity. The removal of sea grass slab 20 from digger/planter 2 is further assisted by sweep arm 47 outer edges 46 and 48 of which push sea slab 20 out of digger/planter 2 on its furrow 25.

With the deposit of slab 20 into furrow 25 the planting sequence is completed by drawing digger/planter 2 upward in the direction of arrow 37 by the action of hydraulic cylinder 32. With this upward movement the planting cycle is complete and boat 1 is moved to a location where a new slab of sea grass can be dug and thereafter the planting sequence is repeated.

The unitary process of this invention consist of the following steps:

1. Digging a slab of sea grass with a bucket having arcuate surfaces;

2. Transporting the slab of sea grass to a new location;

3. With the same apparatus which was used to dig the sea grass slab, dig a furrow and;

4. Sweep the sea grass slab from the bucket into the formed furrow;

In particular referring to FIGS. 2-6 it can be seen that the interior surfaces of primary jaws 22 and 24 are arcuate. As a result of these arcuate interior surfaces under when primary jaws 22 and 24 are opened the sea grass slab 20 as is contained does not stick in bucket 2 during the planting sequence. In contrast the prior art surfaces of bucket 2 are planar. As a result of the incorporation of arcuate interior surfaces 65 and 66 into bucket 2 the tendency for a slab of sea grass to stick in bucket 2 during the planting step of the process is minimized. In the manner as is shown in FIG. 5 interior surfaces 65 and 66 are in contact with the underside of the sea grass slab 20 which is being planted.

Using alternate bucket 2 a slab of sea grass 20 may be easily dug, transported and transplanted. Because bucket 2 has arcuate interior surfaces 65 and 66, a slab of sea grass as may be contained in bucket 2 will readily fall out of bucket 2. For purpose of assisting in the removal of the contained sea grass slab 20, sweep arms 47 provides a positive mechanical assist for this removal.

The above description and drawings are illustrative of modifications that can be made without departing from the present invention, the scope of which is to be limited only by the following claims.

What is claimed is:

1. a process for transplanting a plurality of sea grass plants in a unitary operation which comprises the steps of,
a. with a clam shell bucket having arcuate inner surfaces digging a slab of sea grass which contains a plurality of sea grass plants,
b. transporting the slab of sea grass to a predetermined location,
c. with the same apparatus which is used to dig the slab of sea grass dig a furrow while the slab of sea grass is contained therein and,
d. depositing the slab of sea grass in the furrow.

2. The process of claim 1 wherein the process is carried out on a vehicle which is floating on the surface of the water as may be contained in a estuary.

3. The process of claim 2 wherein the vehicle is a bihulled boat.

4. The process of claim 2 wherein the vehicle is a barge.

5. The process of claim 1 wherein the clam shell bucket has a pair of primary jaws which are used to dig the sea grass slab and associated with said primary jaws is a pair of secondary jaws which are used to dig the furrow.

6. The process of claim 2 wherein the clam shell bucket has a pair of primary jaws which are used to dig the sea grass slab and associated with said primary jaws is a pair of secondary jaws which are used to dig the furrow.

7. The process of claim 3 wherein the clam shell bucket has a pair of primary jaws which are used to dig the sea grass slab and associated with said primary jaws is a pair of secondary jaws which are used to dig the furrow.

8. The process of claim 4 wherein the clam shell bucket has a pair of primary jaws which are used to dig the sea grass slab and associated with said primary jaws is a pair of secondary jaws which are used to dig the furrow.

9. The process of claim 1 wherein the sea grass slab falls into the furrow as the furrow is dug and a sweep arms is provided for to assist in the removal of the sea grass slab from the clam shell bucket.

10. The process of claim 2 wherein the sea grass slab falls into the furrow as the furrow is dug and sweep arm is provided for the assist in the removal of the sea grass slab from the clam shell bucket.

11. The process of claim 3 wherein the sea grass slab falls into the furrow as the furrow is dug and a sweep arm is provided for the assist in the removal of the sea grass slab from the clam shell bucket.

12. The process of claim 4 wherein the sea grass slab falls into the furrow as the furrow is dug and a sweep arm is provided for to assist in the removal of the sea grass slab from the clam shell bucket.

13. The process of claim 5 wherein the sea grass slab falls into the furrow as the furrow is dug and a seep arm is provided for to assist in the removal of the sea grass slab from the clam shell bucket.

14. The process of claim 6 wherein the sea grass slab falls into the furrow as the furrow is dug and a sweep arms is provided for to assist in the removal of the sea grass slab from the clam shell bucket.

15. The process of claim 7 wherein the sea grass slag falls into the furrow as it is dug and a sweep arms is provided for to assist in the removal of the sea grass slab for the clam shell bucket.

16. The process of claim 8 wherein the sea grass slab falls into the furrow as it is dug and a sweep arm is provided for to assist in the removal of the sea grass slab from the clam shell bucket.

17. A digger/planter for sea grass slabs in water comprising a floatable platform which has an access to the surface of the water, a support positioned approximate said access, a digger/planter attached to said support, means attached to said support and to the digger/planter which allows the vertical movement of said digger/planter through the access, said digger/planter having a pair of primary arcuate clam shell jaws which are adapted to dig a slab of sea grass, approximate said primary arcuate jaws are a pair of secondary jaws which are adapted to engage the estuary bottom and dig a furrow in said estuary bottom.

18. The digger/planter of claim 17 wherein a sweep arm is provided for, to mechanically assist in the removal of a sea grass as may be contained therein, wherein the outer edges of the sweep arm is approximate the interior surfaces of the arcuate of the clam shell jaws.

19. The digger/planter of claim 17 wherein a lock is provided for to lock the pair of secondary jaws in an essentially vertical stance when said secondary jaws are utilized to dig a furrow in said estuary bottom.

20. The digger/planter of claim 18 wherein a lock is provided for, to lock the pair of secondary jaws in an essentially vertical stance when said secondary jaws are utilized to dig a furrow in said estuary bottom.
